(19) United States
(12) Patent Application Publication
(10) Pub. No.: US 2004/0264610 A1
(43) Pub. Date: Dec. 30, 2004

(54) Interference cancelling method and system for multisensor antenna

(76) Inventors: Claude Marro, Plouguiel (FR); Jean-Philippe Thomas, Trevou Treguignec (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/493,580

(22) PCT Filed: Oct. 23, 2002
(86) PCT No.: PCT/FR02/03637

(30) Foreign Application Priority Data
Oct. 25, 2001 (FR) 0113933

(51) Int. Cl. H04B 7/10

(52) U.S. Cl. 375/347

(57) ABSTRACT

Interference is reduced in a reception system having a multi-pickup antenna and at least one path for deriving an antenna signal from signals received by the different pickups. The transfer function of a first filter, called a first postfilter, is estimated from a reference signal making it possible to regenerate the interference. The antenna signal is filtered by the first postfilter.

The present invention relates in general to an interference reduction method in a multi-pickup reception system as well as to a multi-pickup reception system implementing the above-mentioned interference reduction method. In particular, the invention is used for the sound pickup in the acoustic echo cancellation field, and in the hands-free telephony field.

Before outlining the state of the art, we will establish certain terminological rules and explain certain notations. These comments and explanations apply to the entire description.

Any device capable of transforming a physical quantity into a measuring signal, such as an antenna or an acoustic transducer, is called a pickup. A “multi-pickup reception system” is a reception system using a plurality of such pickups. A “multi-pickup” antenna is an antenna consisting of a plurality of such pickups, such as a network of pickups.

The term “gain” will not be used in the strict sense of the word and, in the following, will cover the gain (gain of more than 1) and the attenuation (gain of less than 1).

The notation A(t,f) represents a quantity a at the time t and at the frequency f. This permits the description of a quantity in the frequency domain which, however, varies in the course of time. As known, the change from the time domain to the frequency domain requires an observation of the quantity a in a time window. In this sense, it is understood that A(t,f) is a value which is known at the point in time t but that its calculation may have required an observation of the value a during a certain time period. A(t,f) can be obtained from a by means of a spectral estimate in a time window. A(t,f) may be a signal, a spectral quantity or the transfer function of a filter which varies in the course of time. In the following, the notations A(t,f) and a will be used interchangeably for indicating a quantity a whose spectrum varies in the course of time.

The notation a (t) is set aside for a quantity a at the point in time t, which varies with respect to time. The notation A(f), in turn, represents a quantity a at the frequency f, that remains constant with respect to time (for example, the transfer characteristic of a constant filter).

In the following, the notation “\hat{ }” indicates an estimate of the quantity to which it applies.

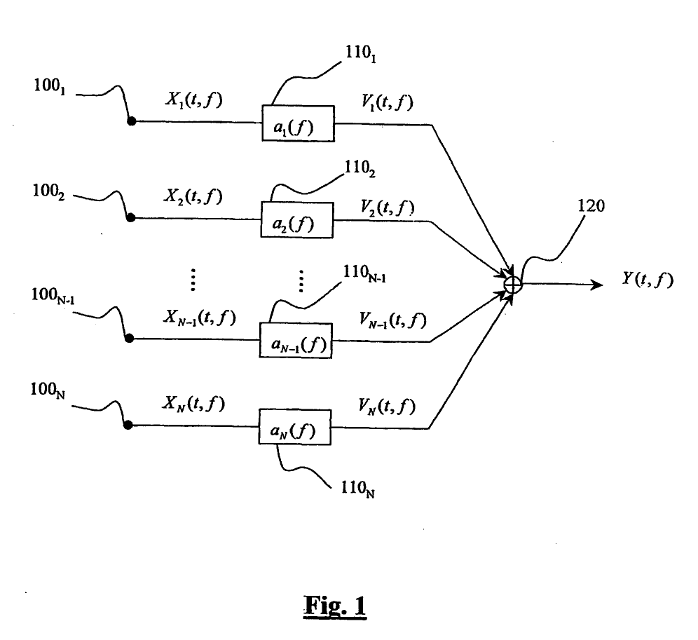

FIG. 1 schematically illustrates a known multi-pickup reception system according to the state of the art. Such a system typically comprises a plurality of pickups 100₁, . . . , 100_{N} for transforming a physical quantity into received signals X₁(t,f), . . . ,X_{N}(t,f), respectively. These signals are then used for implementing a beam forming by means of filters 110₁, . . . ,110_{N} and the adder 120. More precisely, the signals V₁(t,f), . . . ,V_{N}(t,f) at the outputs of filters 110₁, . . , 110_{N} are added in the adder 120 for supplying a signal, called antenna signal, marked Y(t,f). The filters in question introduce delays and/or phase displacements as well as a balancing of the received signals. It is clear that generally the transfer functions of these filters can depend simultaneously on time and frequency. In practice, the filters 110₁, . . . ,110_{N} simply implement a multiplication by means of complex balancing coefficients. These coefficients are determined as a function of the desired reception diagram such that the principal lobe of the reception diagram points in the direction of a useful signal source and has a defined opening angle. The choice of the coefficients is also dictated by the desired attenuation level of the secondary lobes. In the same manner, these coefficients can be determined by introducing one or more zeros into the reception diagram for directions in which interference sources are situated. In addition, the coefficients can be calculated adaptively in order to follow a mobile useful signal source or to reduce interferences arriving at a variable angle of incidence. Nevertheless, this interference reduction technique by means of the reception diagram does not allow the elimination of interfering signals received by the principal lobe of the diagram, which lobe may be large if the number of pickups is low.

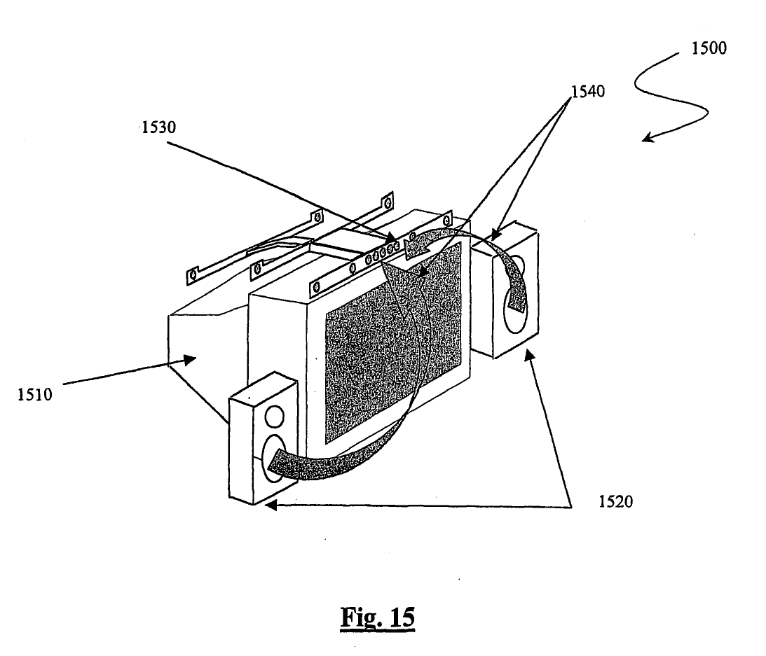

Another technique for eliminating interfering signals calls for knowing or estimating these signals. It is used especially for echo cancellation. It is recalled that an echo is generated in a transmission system when an emitted signal is reflected toward the transmitter after being propagated in the transmission channel. This reflection may be due to characteristics of the channel (especially an impedance adaption defect) or to coupling between a receiver and a transmitter at the near end or the far end of the channel. FIG. 15 illustrates a simple situation in which an echo is generated. A multi-media terminal 1500 is shown here which comprises a monitor 1510, a pair of loudspeakers 1520 and an acoustic multi-pickup antenna 1530 consisting of microphones. The transmission channel is characterized by the direct propagation paths between the loudspeakers and the user (situated in front of the multi-media terminal). The arrows 1540 illustrate the echo generating phenomenon which here can be attributed to the acoustic coupling between the loudspeakers and the acoustic antenna. The coupling is the result of the propagation paths between the loudspeakers and the antenna as well as the reflections of the signals emitted by the loudspeakers in the environment of the terminal (persons, walls, objects, etc.).

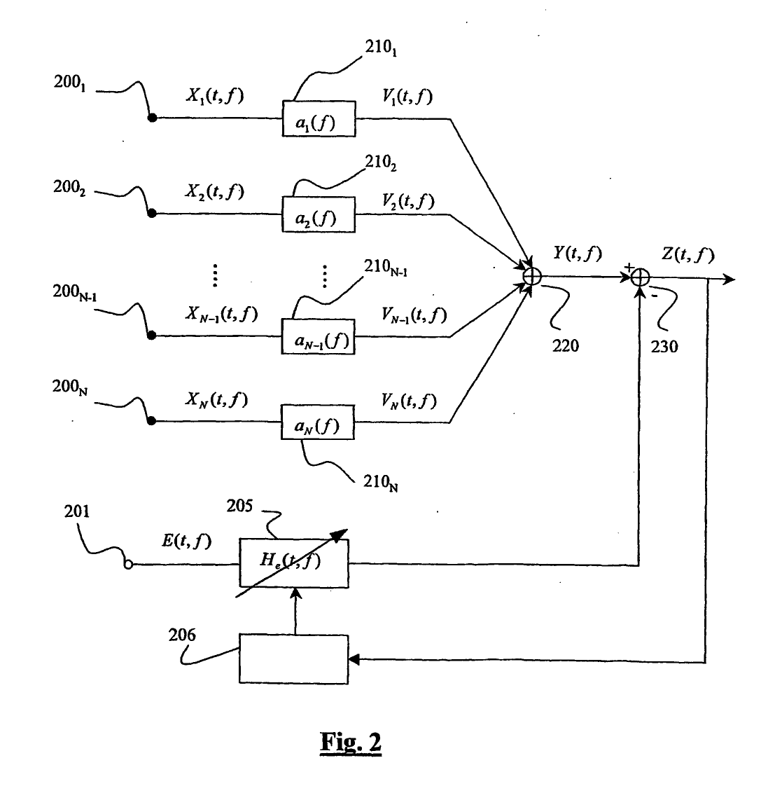

FIG. 2 schematically reproduces a known reception system for the echo cancellation, as described, for example, in the article by W. Kellermann entitled “Strategies for Combining Acoustic Echo Cancellation and Adaptive Beam-Forming Microphone Arrays”, published in April 1997 in Proc. ICASSP-1997, Vol. 1, Pages 219-222. FIG. 2 shows the multi-pickup system of FIG. 1 consisting of the pickups 200₁, . . . ,200_{N}, of the filters 210₁, . . . ,210_{N} and of the adder 220. In addition, the system comprises an element 201 which symbolizes a pickup or an intake which makes it possible to obtain a reference signal e of the interfering signal, marked E(t,f) in a frequency representation. In a general manner, a picked-up or retained signal will be called a reference signal of the interfering signal, permitting the reconstruction of the interfering signal. For example, in the system of FIG. 15, the reference signal can be the signal transmitted to a loudspeaker, and the element 201 can be an intake at the command circuit of the loudspeaker. The reference signal e is filtered by an echo-canceling filter 205 having the transfer function Hₑ(t,f). In fact, this filter shapes the echo propagation channel. The output of the filter is subtracted from the antenna signal 230 for supplying a signal Z(t,f), ideally relieved of the echo. In the context of audio or speech signals, this echo cancellation technique is also called an adaptive acoustic echo cancellation. In fact, the coefficients of the echo cancellation filter 205 are calculated in an adaptive manner in the calculation module 206 in order to minimize the mean quadratic value of the error signal Z(t,f).

If several interference sources are present, it is difficult to implement the adaptive acoustic echo cancellation technique. For example, in the case of a multi-media terminal, if the sound has a spatial character (several loudspeakers reproducing different spatial components), it is extremely complex to take all echoes into account. In addition, when the antenna is a multi-path antenna, that is, if several reception diagrams are generated by a plurality of filter sets having different paths, the problem of the echo cancellation for the different paths is quasi insoluble.

After all, the performances of the acoustic echo cancellation devices are limited by the dimensions of the room in which the sound intake system is used. In fact, in the case of large rooms, the echo cancellation device has to identify an impulse-type acoustic response (transfer function Hₑ(t,f)) which can take several seconds, which involves a considerable increase in the numerical complexity of the adaptation algorithm. In addition, the duration of the impulse-type response to be identified directly influences the performances of the algorithm: The convergence time (that is, the adaptation speed of the filter) as well as the disarrangement (that is, the difference between the effective reduction of the echo level and the maximum theoretical reduction) rise with the duration of the impulse-type response. Thus, if the impulse-type response suddenly changes, the new echo might be filtered in an erroneous manner for several seconds, which may have a particularly annoying effect on the ear.

The general object of the present invention is to provide a method for the elimination of interfering signals of a multi-pickup reception system, which does not exhibit the disadvantages of the state of the art. In particular, it is one of the purposes of the present invention to provide a method of eliminating interference signals, especially an echo, wherein the method has an adaptation speed higher than in the state of the art. A secondary object of the present invention is to provide a simple method of eliminating interfering signals, which can take into account a plurality of interference sources, also when the reception system is a multi-path system.

This problem is solved by means of the invention defined by an interference reduction method for a reception system using a multi-pickup antenna and at least one path generator for supplying an antenna signal from signals received by the different pickups of the above-mentioned antenna. According to this method, the transfer function of a first filter, called a first postfilter, is estimated from a reference signal, making it possible to regenerate the above-mentioned interference, and the above-mentioned antenna signal is filtered by the above-mentioned first postfilter.

The above-mentioned transfer function is advantageously obtained from a short-term estimate and from a long-term estimate of the spectral density of the above-mentioned reference signal, for example, from a ratio of these two estimates.

The short-term estimate and the long-term estimate of the spectral density are preferably obtained by low-pass filtering a spectrum of the reference signal. For example, the short-term estimate \hat{Φ}ₑₑ^{CT}(t,f) of the spectral density is obtained by a recursive filter of the following type:

\hat{Φ}ₑₑ^{CT}(t,f)=α\hat{Φ}ₑₑ^{CT}(t−δt,f)+(1−α)E(t,f)E*(t,f)

wherein E(t,f) is the spectral component of the reference signal at frequency f and at time t; α is a coefficient between 0 and 1; δt is the delay in the loop of the recursive filtration and .* indicates the conjugation operation; and the long-term estimate \hat{Φ}ₑₑ^{LT}(t,f) of the spectral density is obtained by a recursive filter of the following type:

\hat{Φ}ₑₑ^{CT}(t,f)=α₁\hat{Φ}ₑₑ^{LT}(t−δt,f)+(1−α₁)E(t,f)E*(t,f) \hat{Φ}ₑₑ^{LT}(t,f)<\hat{Φ}ₑₑ^{CT}(t,f)

and

\hat{Φ}ₑₑ^{CT}(t,f)=α₂\hat{Φ}ₑₑ^{LT}(t−δt,f)+(1−α₂)E(t,f)E*(t,f) \hat{Φ}ₑₑ^{LT}(t,f)≧\hat{Φ}ₑₑ^{CT}(t,f)

wherein α₁ and α₂ are coefficients, such that 0<α₂<α₁<1.

According to a second embodiment, since the signals received by the different pickups are filtered by at least one set of the path filters before being added up for driving the above-mentioned antenna signal, the transfer function of a second filter, called second postfilter, is estimated from the above-mentioned received signals, before or after the filtering by the above-mentioned path filters, and the antenna signal is filtered by the above-mentioned second postfilter. The transfer function of the above-mentioned second postfilter is advantageously estimated from the mean power spectral densities and from the mean power interspectral densities of the above-mentioned received signals, after filtering by the above-mentioned path filters. The transfer function Wₛ(t,f) of the above-mentioned second postfilter is, for example, estimated by:

$${\hat{W}}_{s} ( t , f ) = \frac{{\sum }_{i - 1}^{N} {\vert {b}_{i} ( f ) \vert}^{2} γ ( {\sum }_{i = 1}^{N - 1} {\sum }_{j = i + 1}^{N} {\hat{Φ}}_{{v}_{i} {v}_{j}} ) ( t , f )}{γ ( {\sum }_{i - 1}^{N - 1} {\sum }_{j = 1 + 1}^{N} {b}_{i} ( f ) {b}_{j}^{*} ( f ) ) {\sum }_{j = i + 1}^{N} {\hat{Φ}}_{{v}_{i} {v}_{i}} ( t , f )}$$

wherein \hat{Φ}ᵥ_{ᵢ}ᵥ_{ⱼ}(t,f) and \hat{Φ}_{yy}(t,f) respectively are estimates of the spectral densities and of the interspectral densities of the power of the received signals after the signals have passed through the path filters; bᵢ(f) are the transfer functions of the different path filters without the rephasing terms; N is the number of pickups of the antenna and γ(.) indicates the absolute value or the modulus.

According to another variant of the second embodiment, since the signals received by the different pickups are filtered by at least one set of the path filters before being added up for driving the above-mentioned antenna signal, the transfer function of a second filter, the above-mentioned second postfilter, is estimated from the above-mentioned signals received after the signals have been filtered by the above-mentioned path filters, as well as from the antenna signal, and the antenna signal is filtered by the above-mentioned second postfilter. The transfer function of the above-mentioned second postfilter is advantageously estimated from the mean of the interspectral densities of the power of the above-mentioned received signals, after the signals have been filtered by the above-mentioned path filters, and from an estimate of the spectral density of the antenna signal. For example, the transfer function Wₛ(t,f) of the above-mentioned second postfilter is estimated by:

$${\hat{W}}_{s} ( t , f ) = \frac{\frac{2}{{N ( N - 1 )}^{γ}} ( {\sum }_{i = 1}^{N - 1} {\sum }_{j = i + 1}^{N} {\hat{Φ}}_{{v}_{i} {v}_{j}} ) ( t , f )}{{\hat{Φ}}_{yy} ( t , f )}$$

wherein \hat{Φ}ᵥ_{ᵢ}ᵥ_{ⱼ}(t,f) and \hat{Φ}_{yy}(t,f) respectively are the spectral and interspectral densities of the power of the received signals after the path filtration; bᵢ(f) are the transfer functions of the different path filters without the rephasing terms; N is the number of pickups of the antenna and γ(.) indicates the absolute value or the modulus.

Advantageously, filtering of the antenna signal by the first postfilter and that by the second postfilter are applied in a combined manner, by filtering the antenna signal by means of a postfilter, the above-mentioned first combined postfilter has as its transfer function the combination of the transfer functions of the above-mentioned first and second postfilters.

According to a third embodiment, a statistical analysis is carried out of the spectral components of the transfer function of the second postfilter and/or of the transfer function of the first combined postfilter, and an indication of the presence or absence of a useful signal is deduced therefrom. According to a variant of the third embodiment, the statistical analysis is also carried out with respect to the spectral components of the transfer function of the first postfilter. The above-mentioned statistical analysis advantageously uses a spectral occupation rate criterion and/or a variance criterion of the above-mentioned spectral components. According to the third embodiment, a commutation signal is generated from the above-mentioned indication of the presence or absence of the useful signal, and the antenna signal is filtered by means of the first combined postfilter when the commutation signal is in a first state, and it is filtered by means of a second combined postfilter when the commutation signal is in a second state, the transfer function of the second combined postfilter being a combination of the transfer function of the first postfilter and of a predetermined attenuation.

According to a fourth embodiment, since the received signals are filtered by a plurality of path filter sets for forming a plurality of path signals, a statistical analysis is carried out of the spectral components of the transfer functions of the second postfilters associated with different path filter sets, and the path offering the highest probability of the presence of a useful signal is deduced therefrom.

According to a variant of the fourth embodiment, the statistical analysis is also carried out with respect to spectral components of the transfer function of the first postfilter. The above-mentioned statistical analysis advantageously uses a spectral occupation rate criterion and/or a variance criterion of the above-mentioned spectral components. The antenna signal is then obtained from path signals relative to the path having the highest probability of a presence of the useful signal.

The invention is also defined by a reception system comprising a multi-pickup antenna, at least one path generator and interference reduction means, the above-mentioned interference reduction means being adapted to carry out the above-mentioned interference reduction method.

The characteristics of the invention mentioned above as well as other characteristics become more clearly apparent in the following description of embodiments, this description referring to the enclosed drawings.

FIG. 1 is a schematic view of a multi-pickup reception system known according to the state of the art;

FIG. 2 is a schematic view of a multi-pickup reception system with an echo cancellation, as known according to the state of the art;

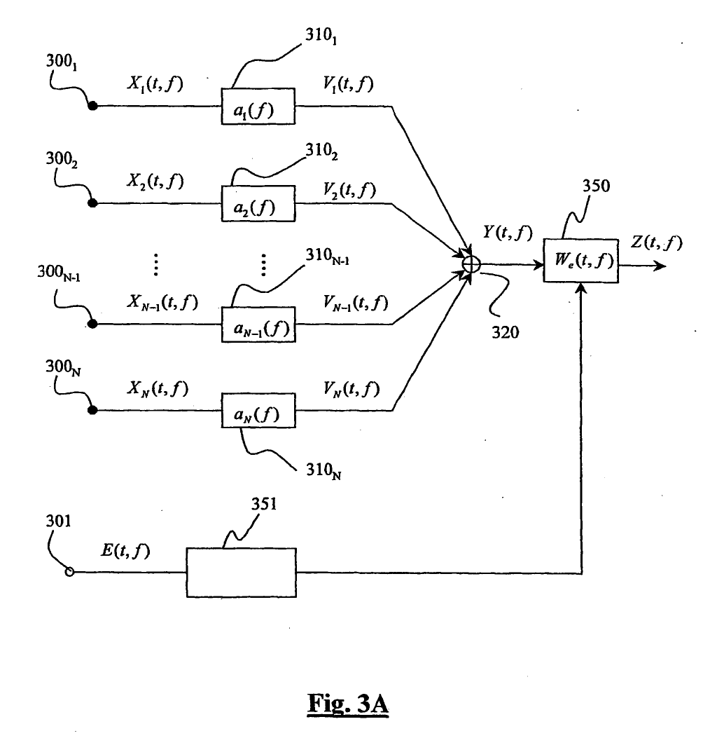

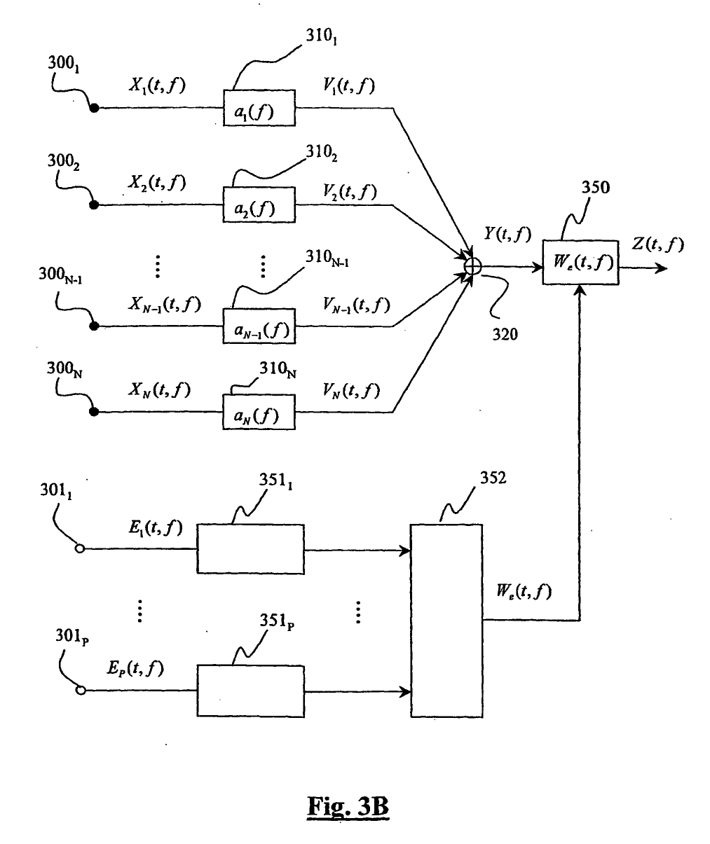

FIG. 3A is a schematic view of a multi-pickup reception system according to a first embodiment of the invention;

FIG. 3B is a schematic view of a multi-pickup reception system according to a variant of the first embodiment of the invention;

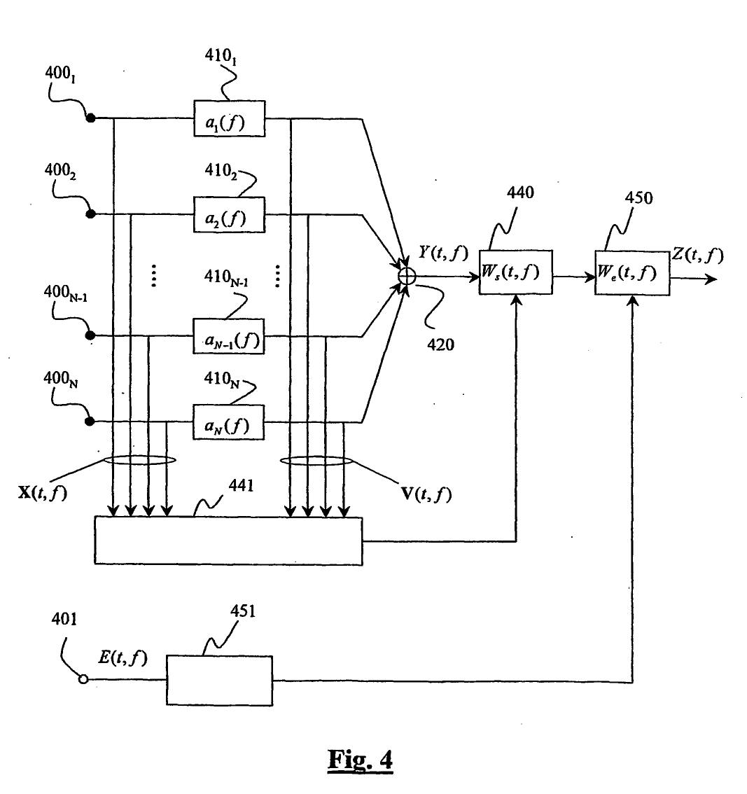

FIG. 4 is a schematic view of a multi-pickup reception system according to a second embodiment of the invention;

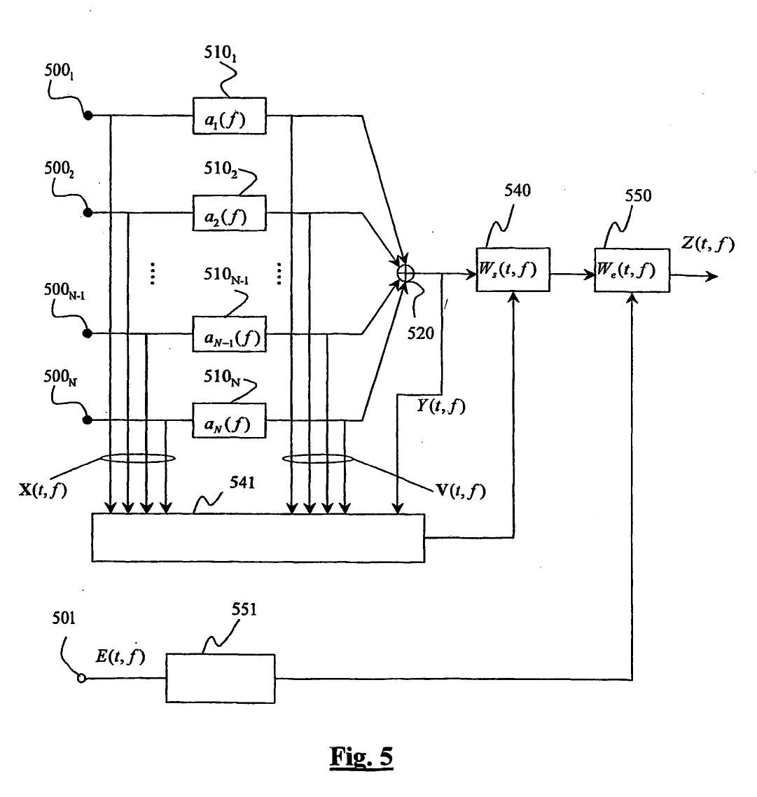

FIG. 5 is a schematic view of a multi-pickup reception system according to a variant of the second embodiment of the invention;

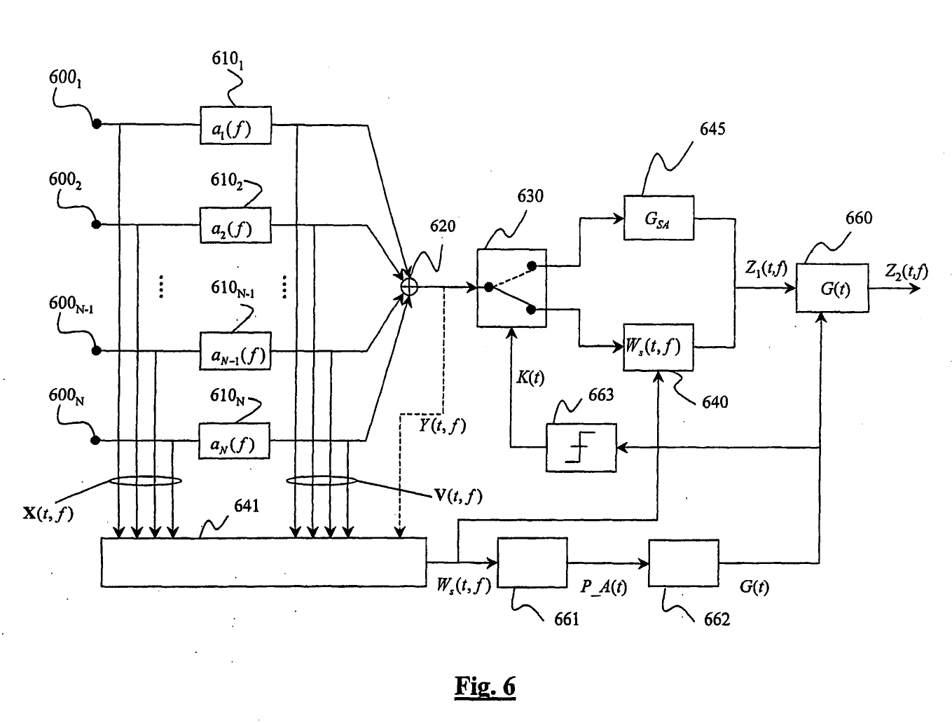

FIG. 6 is a schematic view of a multi-pickup reception system according to the invention which has a useful signal detection;

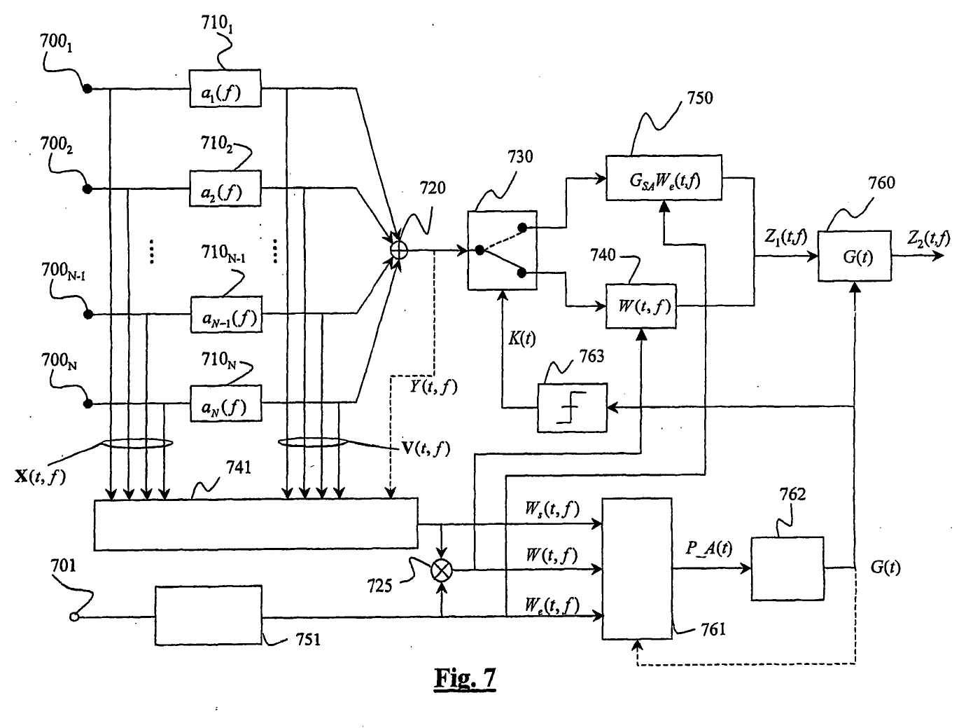

FIG. 7 is a schematic view of a multi-pickup reception system according to a third embodiment of the invention;

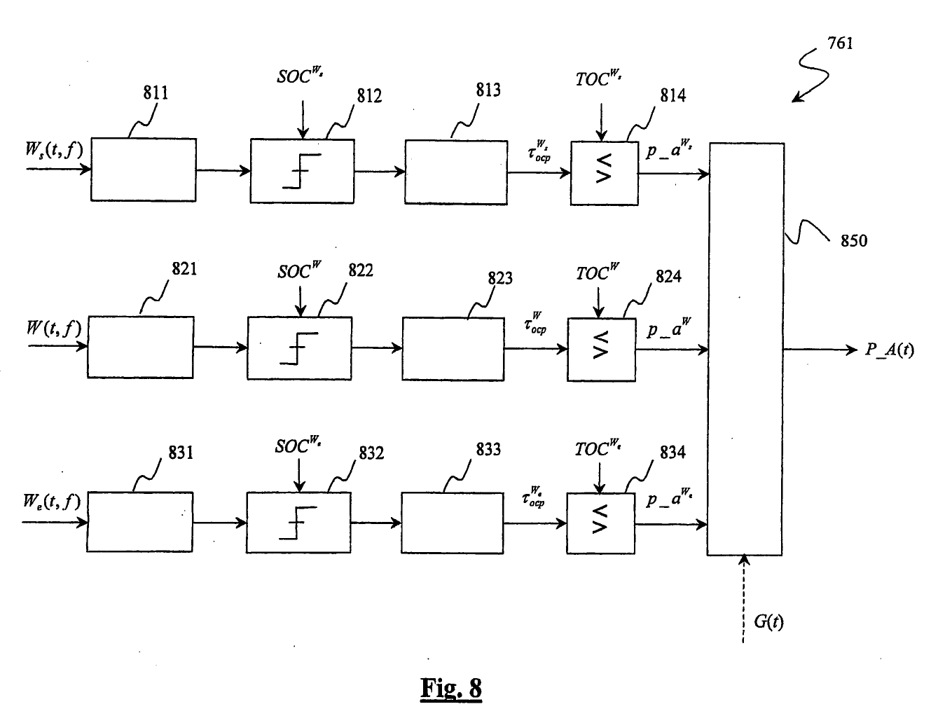

FIG. 8 is a schematic view of a module of the multi-pickup reception system illustrated according to FIG. 7 according to a first variant of the embodiment;

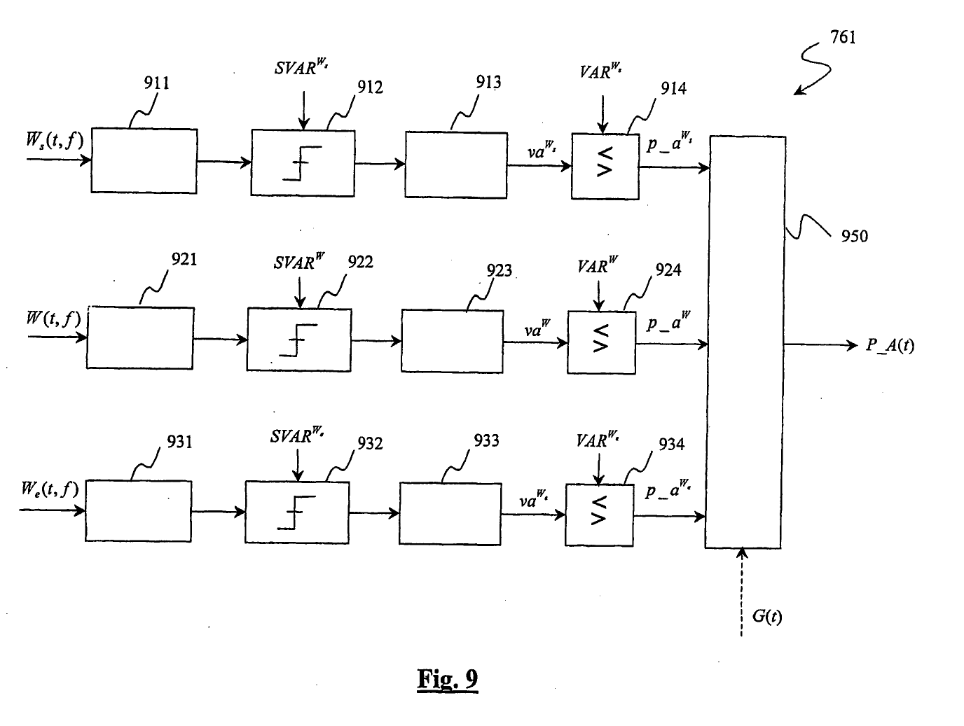

FIG. 9 is a schematic view of a module of the multi-pickup reception system illustrated according to FIG. 7 according to a second variant of the embodiment;

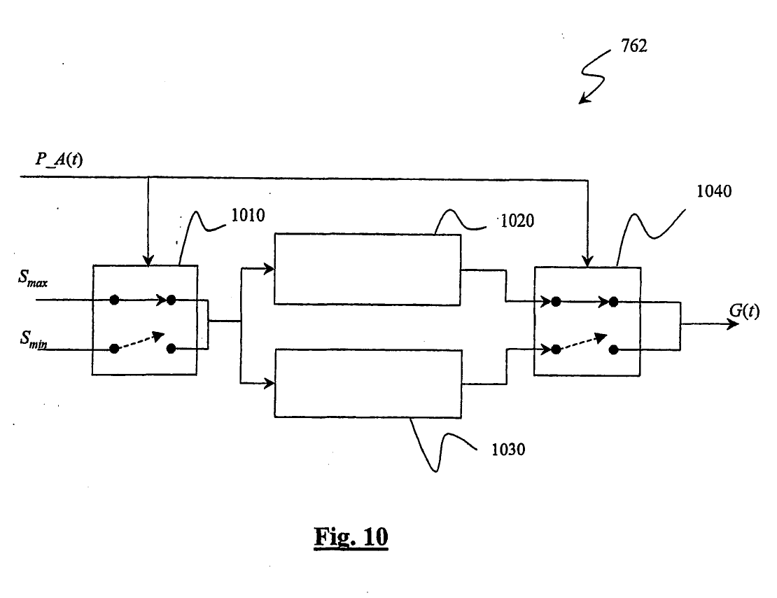

FIG. 10 is a schematic view of another module of the multi-pickup reception system illustrated in FIG. 7;

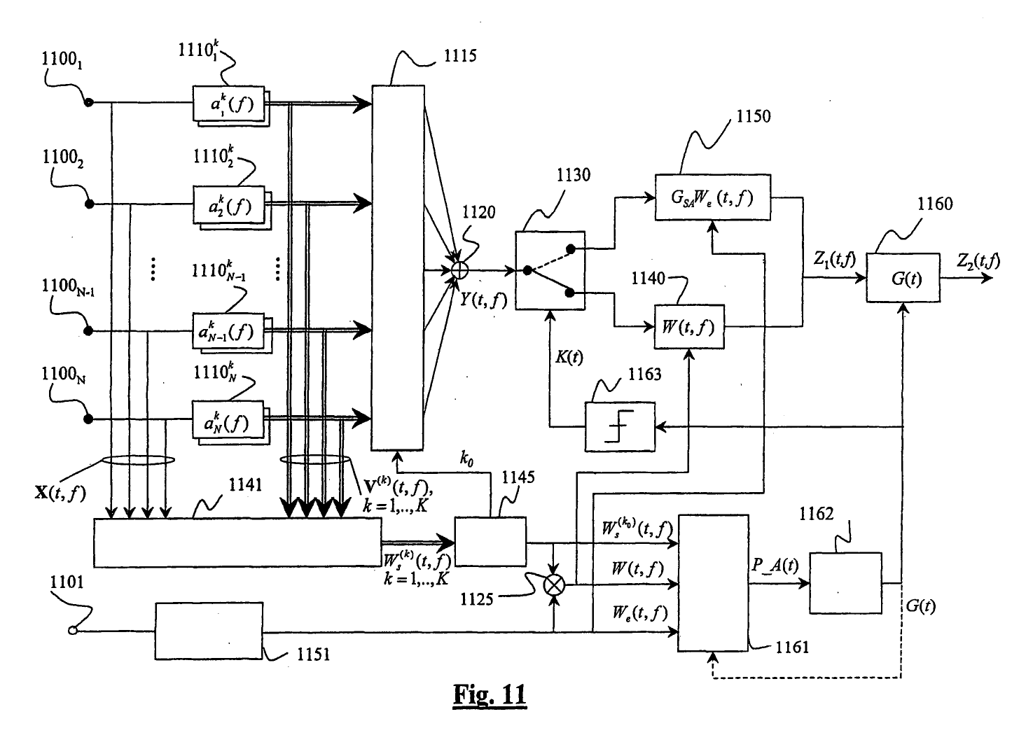

FIG. 11 is a schematic view of a multi-pickup reception system according to a fourth embodiment according to the invention;

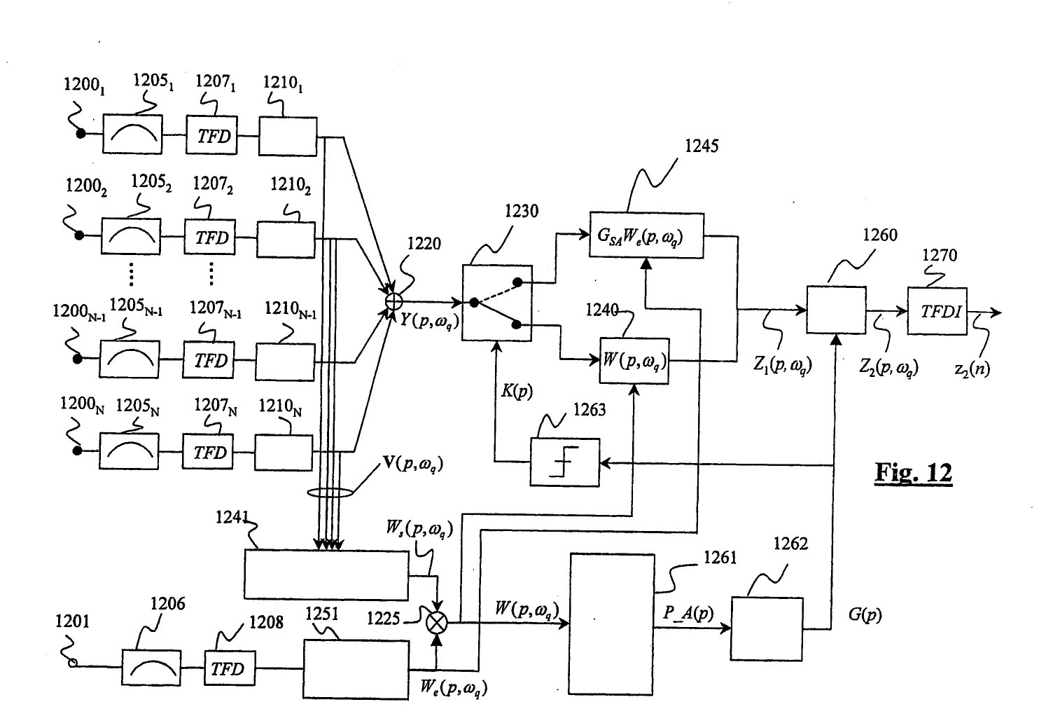

FIG. 12 is a view of an example of the multi-pickup reception system according to the third embodiment of the invention;

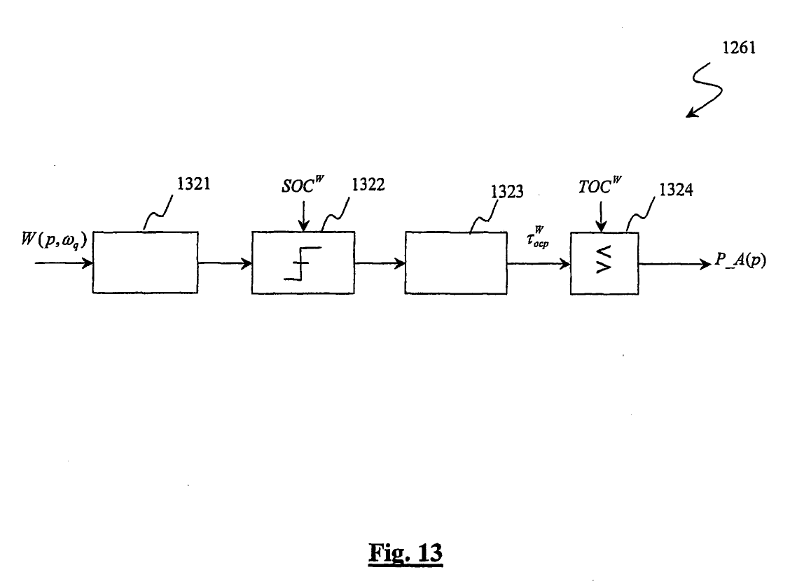

FIG. 13 is a schematic view of a module of the multi-pickup reception system illustrated in FIG. 12;

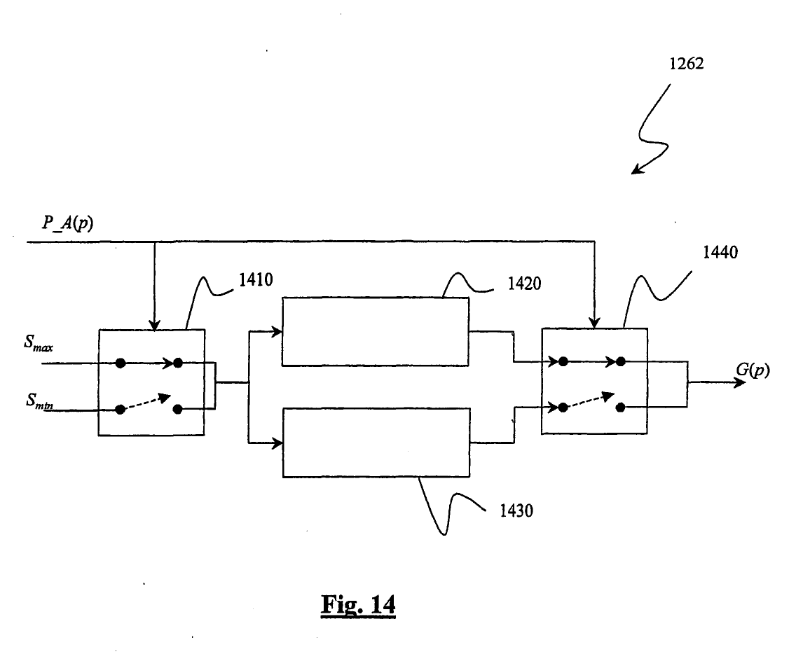

FIG. 14 is a schematic view of another module of the multi-pickup reception system illustrated in FIG. 12;

FIG. 15 is a schematic view of a use of a multi-pickup reception system according to the invention.

Reference is made again to the context of a multi-pickup reception system and to the case in which reference is made to the interfering signal. FIG. 3A illustrates a first embodiment of the invention. It contains the reception system comprising a plurality of pickups 300₁, . . . ,300_{N}, filters 310₁, . . . ,310_{N} and an adder 320 implementing the path formation. An element 301—a pickup or intake—derives a reference signal e indicative of an interfering signal. From the above-mentioned signal, an estimation module 351, which will be described in detail below, calculates the transfer function Wₑ(t,f) of a filter 350 at the antenna output which, for this reason, is called a “postfilter”. From the estimation module, the postfilter 350 receives the information permitting it to implement the above-mentioned transfer function. The path signal (or the antenna signal) Y(t,f) filtered by the postfilter 350 is called Z(t,f).

Generally, the transfer function Wₑ(t,f) of the postfilter is determined in such a manner that, in the absence of an interfering signal, it has a value of 1 (the filter 350 is “transparent”). In the presence of an interfering signal, filter 350 reaches the frequency components of the antenna signal corresponding to the power components of the interfering signal.

More precisely, the estimation module 351 advantageously calculates the transfer function Wₑ(t,f) of the postfilter in the following manner:

$${W}_{e} ( t , f ) = \frac{{\hat{Φ}}_{ee}^{LT} ( t , f )}{{\hat{Φ}}_{ee}^{CT} ( t , f )} \qquad ( 1 )$$

wherein \hat{Φ}ₑₑ^{CT}(t,f) is the estimated short-term spectral density of the power (dsp) of the reference signal e, and wherein \hat{Φ}ₑₑ^{LT}(t,f) is the estimated long-term spectral density of the power of the reference signal e.

The long-term estimate permits development of background noise, and the short-term estimate permits development of the emergences of the interfering signal. In the presence of background noise alone, in other words, in the absence of an interfering signal, the transfer function Wₑ(t,f) is approximately 1. In contrast, in the presence of an interfering signal, transfer function Wₑ(t,f) represents the inverse of the spectral power of the interfering signal, reduced to the power of the background noise.

It is clear that expressions of Wₑ(t,f) other than those indicated in (1) could also be suitable in so far as they permit the frequency components corresponding to the frequency power components of the interfering signal to the attained.

The short-term and long-term spectral densities are estimated by establishing a periodogram of the reference signal. Advantageously, this establishment is carried out in a recursive manner:

\hat{Φ}ₑₑ^{CT}(t,f)=α\hat{Φ}ₑₑ^{CT}(t−δt,f)+(1−α)E(t,f)E*(t,f) (2)

\hat{Φ}ₑₑ^{LT}(t,f)=α₁\hat{Φ}ₑₑ^{LT}(t−δt,f)+(1−α₁)E(t,f)E*(t,f) \hat{Φ}ₑₑ^{LT}(t,f)<\hat{Φ}ₑₑ^{CT}(t,f) (3)

\hat{Φ}ₑₑ^{LT}(t,f)=α₂\hat{Φ}ₑₑ^{LT}(t−δt,f)+(1α₂)E(t,f)E*(t,f) \hat{Φ}ₑₑ^{LT}(t,f)≧\hat{Φ}ₑₑ^{CT}(t,f) (4)

wherein α is a constant, the above-mentioned short-term time constant, between 0 and 1; and wherein α₁ and α₂ are constants, such as 0<α₂<α₁<1, α₁ represents a long-term time constant, and α₂ represents a long-term time constant. The calculations of the expressions (2) to (4) are implemented simply by means of a recursive filter of the first order, δt being the delay present in the loop of the filter.

The constants α, α₁ and α₂ are omission factors: the value of α₁ is selected to be very close to 1 in order to take into account the long past time period, whereas the values of α₁ and α₂ are selected to be lower in order to react more rapidly to the variations of the spectral density of the reference signal.

Other types of a low-pass filters can well be considered for the establishment of the periodogram of the reference signal.

Although the estimation method of the long-term spectral density and the short-time spectral density described above operate in the frequency domain, it is clear, however, that spectral estimation methods in the time domain can also be used, for example, from an autocorrelation of the reference signal e.

FIG. 3B illustrates a variant of the first embodiment of the invention. This variant is applied in the presence of a plurality of interfering signals. If e₁, . . . e_{P} are the respective reference signals relative to these interference signals, they are retained or received by 301₁, . . . 301_{P}. The signals e₁, . . . e_{P} are subjected to short-term and long-term spectral estimates in the respective estimation modules 351₁, . . . ,351_{P}. Each of these modules also calculates a transfer function of a postfilter according to 1. The elementary transfer functions Wₑ₁(t,f), . . . ,W_{eP}(t,f) are then combined in a combination module 352 for supplying a global transfer function Wₑ(t,f). Here, the term “combination” should be understood in a wider sense: It may specifically be a linear combination or preferably a multiplication of the elementary transfer functions. In all cases, the module 352 transmits information to the postfilter 350 which permits the implementation of the above-mentioned global transfer function. The P interfering signals are ideally removed from the antenna signal Y(t,f) filtered by the postfilter 350.

FIG. 4 illustrates a second embodiment of the invention. It has a plurality of pickups 400₁, . . . ,400_{N}, of path filters 410₁, . . . ,410_{N}, each filtering the signals received by the different pickups, and an adder 420 permitting the carrying-out of the path formation. At 401, the reference signal e of an interference signal is received or retained. As previously, the estimation module 451 determines the transfer function Wₑ(t,f) of the postfilter 450. This embodiment differs from the previous one in that it provides an additional postfiltration by means of a postfilter 440 situated upstream or downstream of the postfilter 450. The postfilter 440 has a transfer function Wₛ(t,f) supplied by an estimation module 441 which will be described in greater detail below. According to a variant of the embodiment, which is not shown, the filters 440 and 450 can be replaced by a single filter having the transfer function W(t,f) obtained by the combination (in a wider sense) of the transfer functions Wₑ(t,f) and Wₛ(t,f). The following can, for example, be chosen:

W(t,f)=Wₛ(t,f)Wₑ(t,f) (5)

or, in a more general manner:

W(t,f)=Wₛ^{μ}(t,f)Wₑ^{v}(t,f) (6)

where μ, v are strictly positive totals.

The purpose of postfilter 440 is to improve the signal-to-noise ratio (RSB) at the output of the antenna. Here, “noise” means the total of the disturbing signals for which no reference is provided. If a reference of a disturbing signal is provided, the latter can be taken into account in the expression Wₑ(t,f), as illustrated in FIG. 3B.

The postfiltering technique for improving the signal-to-noise ratio at the output of a multi-pickup antenna was specifically described in the article by C. Marro et al. entitled “Analysis of Noise Reduction and Deverberation Techniques Based on Microphone Arrays with Postfiltering”, published in May 1998 in IEEE Trans. on Speech and Audio Processing, Vol. 6, No. 3, PP. 240-259. Its principal results will be recalled in the following.

We will consider the case in which a source emits a useful signal s. This signal is received by the different pickups 400₁, . . . ,400_{N} after being propagated to the antenna. The signals received by the different pickups are disturbed by noise. nᵢ represents the noise at pickup 400ᵢ. We will make the following suppositions:

the signal xᵢ at pickup i is shaped by the sum of the useful signal received after propagation to the pickup and of the noise nᵢ;

the noise nᵢ and the received useful signal are decorrelated at each pickup;

the spectral power densities of the noises nᵢ identical at each pickup;

the noises are decorrelated between pickups 400ᵢ and 400ⱼ; in other words, the interspectral power densities are zero for i≠j;

the input signals xᵢ are perfectly phased again with respect to s by the filters 410₁, . . . 410_{N}.

The optimal postfilter Wₛ is that which minimizes the mean quadratic error between the wanted signal s and the signal at the filter output. As illustrated in the article by K. U. Simmer et al. entitled “Time Delay Compensation for Adaptive Multichannel Speech Enhancement Systems”, published in Proc. ISSE 92 in September 1992, the expression of this optimal filter can be written from the useful signal s and the mean noise \overline{n} at the antenna output:

$${W}_{s} ( t , f ) = \frac{{\hat{Φ}}_{ss} ( t , f )}{{\hat{Φ}}_{ss} ( t , f ) + {\hat{Φ}}_{\overline{nn}} ( t , f )} \qquad ( 7 )$$

wherein \hat{Φ}ₛₛ(t,f) and \hat{Φ}_{\overline{nm}}(t,f) are the spectral power densities of the useful signal and of the noise at the output of the path formation.

The spectral densities \hat{Φ}ₛₛ(t,f) and \hat{Φ}_{\overline{nm}}(t,f), necessary for the calculation of Wₛ(t,f), are a priori unknowns and their estimation is difficult. It was suggested that they be estimated from signals received at the different pickups. In fact, if the spectral and interspectral power densities of the rephased signals xᵢ, that is, of signals vᵢ, are written \hat{Φ}ᵥ_{ᵢ}ᵢ(t,f) and \hat{Φ}ᵥ_{ᵢ}ᵥ_{ⱼ}(t,f)

\hat{Φ}ᵥ_{ᵢ}ᵥ_{ᵢ}(t,f), respectively, the following is obtained using the following hypotheses:

Φᵥ_{ᵢ}ᵥ_{ᵢ}(t,f)=Φₛₛ(t,f)+Φₙₙ(t,f) (8)

Φᵥ_{ᵢ}ᵥ_{ᵢ}(t,f)=Φₛₛ(t,f) pour i≠j (9)

A means of estimating Wₛ(t,f) then consists of using a mean of the spectral \hat{Φ}ᵥ_{ᵢ}ᵥ_{ᵢ}(t,f) and interspectral \hat{Φ}ᵥ_{ᵢ}ᵥ_{ᵢ}(t,f) densities respectively in the denominator and in the numerator of (7), such as:

$${\hat{W}}_{s} ( t , f ) = \frac{\frac{2}{{N ( N - 1 )}^{γ}} ( {\sum }_{i = 1}^{N - 1} {\sum }_{j = i + 1}^{N} {\hat{Φ}}_{{v}_{i} {v}_{j}} ) ( t , f )}{\frac{1}{N} {\sum }_{i = 1}^{N} {\hat{Φ}}_{{v}_{i} {v}_{i}} ( t , f )} \qquad ( 10 )$$

wherein γ(.)=Re(.) or γ(.)=|.|

The use of the operator module or real part γ(.) is justified by the fact that the quantity in the numerator must be real and positive.

The module 441 in FIG. 4 performs the estimate of Wₛ(t,f) according to the expression (10). For this purpose, it uses either the signals xᵢ and rephases them, or the signals vᵢ directly. The signals xᵢ and vᵢ are represented in FIG. 4 in the form of vectors X(t,f)=(X₁(t,f), . . . , X_{N}(t,f)) and V(t,f)=(V₁(t,f), . . . , V_{N}(t,f)) where Xᵢ(t,f) and Vᵢ(t,f) are the frequency notations of xᵢ and vᵢ. Thus, the estimation module 441 uses either the vector X(t,f), or the vector V(t,f). The two possibilities are indicated in FIG. 4.

Advantageously, an estimate of Wₛ(t,f) close to expression (10) will be used which, however, exhibits the advantage of being normalized:

$${\hat{W}}_{s} ( t , f ) = \frac{{\sum }_{i - 1}^{N} {\vert {b}_{i} ( f ) \vert}^{2} {α}_{i}^{2} γ ( {\sum }_{i = 1}^{N - 1} {\sum }_{j = i + 1}^{N} {\hat{Φ}}_{{v}_{i} {v}_{j}} ( t , f ) )}{γ ( {\sum }_{i - 1}^{N - 1} {\sum }_{j = i + 1}^{N} {b}_{i} ( f ) {b}_{j}^{*} ( f ) {α}_{i} {α}_{j} ) {\sum }_{i = 1}^{N} {\hat{Φ}}_{{v}_{i} {v}_{j}} ( t , f )} \qquad ( 11 )$$

wherein bᵢ(f) is equal to the coefficient αᵢ(f) of the filter 410ᵢ, without the rephasing term; that is, if one writes τᵢ as the propagation time of the signal between the source of the useful signal and the pickup 400ᵢ, bᵢ(f)=αᵢ(f)e^{j2πτ} wherein αᵢ is the attenuation coefficient between the source of the useful signal and the pickup 400ᵢ. If the distances between pickups are small compared with the distance separating the antenna from the useful source, the attenuation coefficients are the same and the expression (11) can then be reduced to:

$${\hat{W}}_{s} ( t , f ) = \frac{{\sum }_{i - 1}^{N} {\vert {b}_{i} ( f ) \vert}^{2} γ ( {\sum }_{i = 1}^{N - 1} {\sum }_{j = i + 1}^{N} {\hat{Φ}}_{{v}_{i} {v}_{j}} ( t , f ) )}{γ ( {\sum }_{i - 1}^{N - 1} {\sum }_{j = i + 1}^{N} {b}_{i} ( f ) {b}_{j}^{*} ( f ) ) {\sum }_{i = 1}^{N} {\hat{Φ}}_{{v}_{i} {v}_{j}} ( t , f )} \qquad ( 12 )$$

It is fitting to note that the estimate according to (10), (11) or (12) may only relate to a dominating M<N subset of signals xᵢ or vᵢ, the mean of the spectral and interspectral densities then only being taken on this subset. Finally, the above-mentioned estimate can be carried out in the frequency domain or in the time domain.

FIG. 5 illustrates a variant of the second embodiment. The elements 500₁, . . . ,500_{N}, 510₁, . . . ,510_{N}, 520, 501, 550, 551 respectively are identical with elements 400₁, . . . ,400_{N}, 410₁, . . . ,410_{N}, 420, 401, 450, 451 of FIG. 4.

According to this variant, an estimate of the transfer function of the postfilter is used as suggested by U.K. Simmer et al. in the article entitled “Adaptive Microphone Arrays for Noise Suppression in the Frequency Domain” published in Proc. of the Sec. Cost 229 Work on Adaptive Algorithms in Communications, pages 185-194, Bordeaux, France, 1992. This estimate uses the rephased signals xᵢ, that is, signals vᵢ, as well as the antenna signal y. More precisely, Wₛ(t,f) is estimated by:

$${\hat{W}}_{s} ( t , f ) = \frac{\frac{2}{N ( N - 1 )} γ ( {\sum }_{i = 1}^{N - 1} {\sum }_{j = i + 1}^{N} {\hat{Φ}}_{{v}_{i} {v}_{j}} ( t , f ) )}{{\hat{Φ}}_{yy} ( t , f )} \qquad ( 13 )$$

wherein \hat{Φ}_{yy}(t,f) is the spectral density of the antenna signal y.

Here also, as in the preceding case, a normalized estimate can advantageously be adopted, namely:

$${\hat{W}}_{s} ( t , f ) = \frac{γ ( {\sum }_{i = 1}^{N - 1} {\sum }_{j = i + 1}^{N} {\hat{Φ}}_{{v}_{i} {v}_{j}} ( t , f ) )}{γ ( {\sum }_{i - 1}^{N - 1} {\sum }_{j = i + 1}^{N} {b}_{i} ( f ) {b}_{j}^{*} ( f ) {α}_{i} {α}_{j} ) {\hat{Φ}}_{yy} ( t , f )} \qquad ( 14 )$$

with the same notation rules.

Finally, the estimate (13 or (14) may only relate to a subset of signals xᵢ or vᵢ, the mean of the spectral and interspectral densities then only being taken on this subset. The above-mentioned estimate can be carried out in the frequency domain or in the time domain.

The module 541 of FIG. 5 carries out the estimate of Wₛ(t,f) according to the expression (11). For this purpose, it uses, on the one hand, the antenna signal y (Y(t,f) in a frequency representation, and, on the other hand, either the signals xᵢ (vector X(t,f)) after having rephrased them, or the signals vᵢ (vector V(t,f) directly.

As illustrated, the multi-pickup reception signals in FIGS. 4 and 5 considerably improve the signal-to-noise ratio at the output of the antenna. Nevertheless, when a useful signal is absent, the postfilters 440 and 450 or 540 and 550 have a tendency to distort the noise, which can prove to be annoying, particularly in sound intake applications. In order to remedy this inconvenience, it was suggested in Patent Application FR00 05601, filed on 28 Apr. 2000 by the applicant and included here by reference, to not apply the postfilter permanently but only when the useful signal is present, a constant gain being applied in the opposite case. A switching signal, in the following called K(t), ensures the switching at the output of the antenna to drive, either a constant gain filter, or a filter having the transfer function Wₛ(t,f).

FIG. 6 shows a multi-pickup reception system with a switchable postfilter as disclosed in the above-mentioned patent application.

The elements 600₁, . . . , 600_{N}, 610₁, . . . , 610_{N}, 620, 641 respectively are identical with elements 500₁, . . . , 500_{N}, 510₁, . . . ,510_{N}, 520 and 541 (or 441). The broken-line arrow having the reference Y(t,f) indicates that the module 641 can carry out an estimate of Wₛ(t,f) according to (10), (11), (12) or else according to (13) or (14). The frequency components of the transfer function Wₛ(t,f) (or more precisely, of its estimate) are the object of a statistical analysis in the analysis module 661. The latter carries out a group of operations which will be described in greater detail below and which have the purpose of setting by means of a variance and/or spectral occupation rate analysis a mark of the presence of a useful signal in the spectrum of Wₛ(t,f). The module 661 supplies a binary indicator of the presence/absence of the useful signal called P_A(t) which is temporally smoothed in the low-pass filter module 662 having a gain value G(t). This gain value is compared to a threshold value ST in the comparator 663, the result of the comparison K(t) commanding the switching of the antenna output by means of a switch 630, either toward the postfilter 640 or toward attenuator 645 having a constant gain G_{SA}. The respective outputs of the postfilter and of the attenuator are both connected to the input of amplifier 660 having a gain controlled by the gain value G(t).

This reception system makes it possible to avoid the distortion of the residual disturbance when the useful signal is absent. To ensure the continuity during switching, temporal smoothing of the gain is provided. Temporal smoothing of the gain is performed by the low-pass filter 662 and has the object of ensuring a smooth transition while the antenna output is switched.

FIG. 7 illustrates a multi-pickup reception system according to a third embodiment of the invention. This embodiment uses postfiltering and the presence/absence switching of the useful signal of FIG. 6. The elements 700₁, . . . ,700_{N}, 710₁, . . . , 710_{N}, 720, 730, 740, 741, 760, 762, 763 respectively are identical with the elements 600₁, . . . ,600_{N}, 610₁, . . . ,610_{N}, 620, 630, 640, 641, 660, 662, 663 of the latter.

The system of FIG. 7 differs from that of FIG. 6 in that the FIG. 7 system eliminates of interfering signals according to the principle of the invention.

In fact, 701 indicates a element which makes it possible to receive or to retain a reference signal of an interfering signal, and 751 indicates an estimation module identical with the module 351 of FIG. 3A. The estimation modules 741 and 751 respectively estimate the transfer function Wₛ(t,f) of the first postfilter and the transfer function Wₑ(t,f) of a second postfilter. The first postfilter increases signal-to-noise ratio without prejudice to the above-mentioned hypotheses, and the second postfilter eliminates interference (or interferences as in FIG. 3B) for which a reference is used. The transfer functions Wₛ(t,f) and Wₑ(t,f) (or more precisely, their estimates) are supplied, as well as their product W(t,f) obtained by means of the multiplier 725, by a statistical analysis module 761 similar to the module 661, and whose function will be described in detail in the following. This module supplies a binary indicator of the presence/absence of the useful signal P_A(t) which is temporally smoothed to provide the gain G(t). In addition, the output W(t,f)=Wₛ(t,f).Wₑ(t,f) of the multiplier is transmitted to the filter 740. Likewise, the estimation module 751 transmits the indication Wₑ(t,f) to the filter 750, enabling filter 750 to implement the transfer function G_{SA}. Wₑ(t,f).

According to a first variant, the filters 740 and 750 respectively have the transfer functions W(t,f)=Wₛ^{μ}(t,f)Wₑ^{v}(t,f) and G_{SA}Wₑ^{v}(t,f), wherein μ, v are strictly positive totals.

According to a second variant, the attenuation G_{SA} depends on the frequency and remains constant over the time, which especially permits the systematic rejection of certain parts of the spectrum, independently of the interference.

Thus, when a useful signal is present, the output of the antenna is filtered by the combination of the two postfilters as in FIG. 5, whereas, when the useful signal is absent, the output is simply subjected to a filtering by Wₑ(t,f) (or Wₑ^{v}(t,f) and to an attenuation.

The functional diagram of the statistical analysis module 761, according to a first embodiment, is illustrated in FIG. 8.

Since the transfer functions W(t,f), Wₛ(t,f), Wₑ(t,f) are subjected to an analogous treatment, this will be limited to that of function Wₛ(t,f). By means of extraction devices 811, a group of frequencies F_{ocp} fixed by the user is extracted from Wₛ(t,f). The thus obtained spectrum, if required, undergoes a non-linear transformation (not shown) for providing more pertinent information. If necessary, a logarithmic transformation (in volume units) will be advantageously utilized:

W(t,F_{ocp})=20 Log(|Wₛ(f,F_{ocp})|) (15)

The spectral components reduced to the group of frequencies F_{ocp} are then compared to a threshold SOC^{W} in the comparator 812. Then the proportion τ_{ocp}^{W}^{ₛ}(t) of frequencies for which Wₛ(t,F_{ocp}) exceeds a predetermined threshold SOC^{W} is determined in the module 813, such as:

$${τ}_{ocp}^{{W}_{s}} ( t ) = \frac{size of spectrum in {F}_{ocp} such as {W}_{s} ( t , {F}_{ocp} ) > {SOC}^{{W}_{s}}}{size of spectrum of {F}_{ocp}} \qquad ( 16 )$$

The occupation rate τ_{ocp}^{W}^{ₛ}(t) is then compared to a predetermined threshold value TOC^{W} in the comparator 814. This comparison supplies a binary symbol p_a^{W}^{ₛ}. The binary signal p_a^{W}^{ₛ}

indicates that a useful signal is present when the occupation rate τ_{ocp}^{W}^{ₛ}(t) is higher than the threshold TOC^{W}_{S}. In the same manner, the processing chain consisting of the extraction module 821 (or 831), of the comparator 822 (or 832), of the occupation rate calculation module 823 (or 833) and of the comparator 824 (or 834) supplies a binary signal p a^{W} (or p_a^{W}^{ₛ}).

The binary signal p_a^{W}^{ₛ} gives an indication as to the presence of the useful signal without taking into account the interference signal. In return, the binary signal p_a^{W}^{ₑ}

provides an indication with respect to the presence of the interference signal. The binary signal p_a^{w} provides an indication of the presence of the useful signal from global information taking into account both the useful signal and the interference signal.

The three binary signals p_a^{W}^{ₛ}, p_a^{W}, p_a^{W}^{ₑ} are combined in the combination module 850 for providing a binary indicator of the presence/absence of the useful signal P A(t). The used combination function depends on the gain value G(t). In fact, the indicator p_a^{w} may be more or less privileged according to which useful signal is already present or is not present.

According to a first simplified variant, the statistical analysis module only has the processing chains Wₛ(t,f), Wₑ(t,f), and the combination in 850 only relates to the indicators p_a^{W}, and p_a^{W}^{ₑ}. According to a second simplified variant, the statistical analysis module only comprises the process chain W(t,f) and consequently no combination is implemented.

The functional diagram of the statistic analysis module 761, according to a second embodiment, is illustrated in FIG. 9. This example uses a variance criterion instead of a rate of occupying criterion.

Since the transfer functions W(t,f), Wₛ(t,f), Wₑ(t,f) are subjected to analogous processing, this will be limited to that of function Wₛ(t,f). After extraction of the spectral components at a group of frequencies Fᵥₐᵣ fixed by the user in 911 and, if required, a non-linear transformation, limiting of the spectrum to these frequencies is carried out in 912 by means of a predetermined threshold value SVAR^{W}, only the components above the threshold being retained. The variance va^{W} of the spectrum thus obtained is then calculated in 913, then compared with a threshold value VAR^{W} in a comparator 914 for supplying a binary signal p_a^{W}^{ₛ}. The binary signal p_a^{W}^{ₛ} indicates that a useful signal is present when the variance va^{W}^{ₛ} is lower than the threshold value VAR^{w}^{_{S}}. In the same manner, the processing chain consisting of the extraction module 921 (or 931), of the comparator 922 (or 932), of the variance calculation module 923 (or 933) and of the comparator 924 (or 934) supplies a binary signal p_a^{W} (or p_a^{W}^{ₑ}). The three binary signals are combined in 950 that derives the binary indicator P_A(t). The remarks made concerning the first example in FIG. 8 also apply here mutatis mutandis.

According to another variant of the embodiment, the binary signals or the binary indicators obtained according to the occupation rate criterion and the variance criterion can be combined to form a synthetic binary indicator P_A(t).

The low-pass filter 762 is schematically illustrated in FIG. 10. P indicates the state of the presence of the useful signal and A indicates the state of the absence of the useful signal. It is the function of the filter 762 to continuously cause the gain G(t) to decrease toward a value Sₘᵢₙ during the passage from state P to state A, and cause the gain G(t) to increase toward the value Sₘₐₓ during the passage in the inverse direction.

The low-pass filter receives the binary indicator P_A(t) which varies in the course of time. This indicator commands the switching between a minimum gain value Sₘᵢₙ and a maximum gain value Sₘₐₓ owing to a first switch 1010. When the useful signal is present, the maximum value Sₘₐₓ (generally fixed at 1) is injected at the common input of the two low-pass filters 1020 and 1030. When the useful signal is absent, the minimum value Sₘᵢₙ feeds the common input. In order to ensure the continued increase and then the maintenance of G(t) at the value Sₘₐₓ during transitions from state A to state P, the input signal is filtered by the low-pass filter 1020 having the time constant τ_{P}. The choice of this time constant is based on the rise time of the signal G(t). In the same manner, to cause G(t) to decrease continuously and then maintain it at the value Sₘᵢₙ during transitions from state P to state A, the input signal is filtered by the low-pass filter 1030 having a time constant τ_{A}, which conditions the fall time of G(t). The output of the two low-pass filters are connected to the inputs of a second switch 1040 which, owing to the binary indicator P_A(t), selects the output of the low-pass filter having the time constant τ_{A} if the useful signal is absent and the output of the low-pass filter having the time constant τ_{P} when the useful signal is present. The smoothed gain signal G(t) is derived at the common output of the switch 1040.

FIG. 11 illustrates a multi-pickup reception system according to a fourth embodiment of the invention. In contrast to the preceding embodiment, a plurality K of paths are formed by means of K distinct sets of path filters 1110₁^{k}, . . , 1110_{N}^{k}, k=1, . . . ,K, operating parallel, each set permitting the formation of a path in a particular reception direction. The estimation module 1141 estimates the transfer functions Wₛ^{(k)}(t,f), k=1, . . . ,K, of the postfilters associated with these K sets. To implement this, it uses either the K sets of signals v₁^{k}, . . . v_{N}^{k} (represented by the vectors V^{(k)}(t,f) in the output of the K sets of path filters, or the signals xᵢ after compensation by K phase shifting sets. In any case, the transfer functions Wₛ^{(k)}(t,f), k=1, . . . ,K are analyzed on the basis of a variance or spectral occupation rate criterion by a first statistical analysis module 1145, and the path k₀ presenting the highest probability of receiving a useful signal is selected. The indication k₀ generated by the module 1145 selects by means of the multiplexer 1115 the signals v₁^{k}^{₀}, . . . ,v_{N}^{k}^{₀} which supplies them to the adder 1120 for forming the path in question. The transfer function Wₛ^{(k}^{₀}⁾(t,f) of the postfilter associated with the path k₀ is transmitted to a second statistical analysis module 1161 identical with the module 761 of FIG. 7.

According to a variant of the embodiment, the first statistical analysis module 1145 also receives the transfer function Wₑ(t,f) of the estimation module 1151 and takes it into account for the selection of the path k₀. The first statistical analysis module 1145 then carries out all of the statistical analysis operations and directly derives the binary indicator P_A(t). The elements 1130, 1140, 1150, 1160, 1162 and 1163 in the two cases are identical with the elements 730, 740, 750, 760, 762 and 763 of FIG. 7.

FIG. 12 shows an example of the third embodiment of the invention in an application for the intake of hands-free sound for interactive communication contexts (teleconferencing, individual communicating computers, etc.). In one such context, the acoustic echo, that is, the signal of the distant speaker emitted by the loudspeaker constitutes the interfering signal. The disturbing signal e is taken directly at the level of the loudspeaker.

We will now present this example in the framework of numerical processing of the signal in the frequency domain. The temporal samples are indexed by n representing the temporal indication in discrete time.

The representation in the frequency domain is ensured by a discrete Fourier transform in the interior of a sliding temporal window. The signals xᵢ(n) received by the microphones 1200₁, . . . , 1200_{N} are subjected to balancing in the temporal window by means of the filters 1205₁, . . . , 1207_{N}, then to a discrete short-term Fourier transform (TFD) in 1207₁, . . . , 1207_{N}. In the output of the TFD module, a temporal representation Xᵢ(p,w_{q}) is disposed, with:

$${X}_{i} ( p , {w}_{q} ) = {\sum }_{n = 0}^{M - 1} {h}_{a} ( - n ) {x}_{i} ( pR + n ) {W}_{M}^{- qn} \\ for q = 0 , … , M - 1 \qquad ( 17 )$$

wherein the frequency axis is quantized in a uniform manner: w_{q}=2πq=0, . . . ,M−1, with M being the length of the analysis window (in samples); wherein the hₐ(n) are the balancing coefficients in the midst of the analysis window; R is the displacement step of the windows (in samples), and p is the indication of the frame; and wherein W_{M}=e^{j2π/M}=e^{jw}^{₁}.

Reciprocally, in the output of the reception system, the signal Z₂(p,ω_{q}) is transformed in a temporal representation by means of a discrete inverse Fourier transform module 1270 (TFDI), such as

$$\begin{matrix}{z}_{2} ( n ) = {\sum }_{p = - ∞}^{p = + ∞} {h}_{a} ( n - pR ) \frac{1}{M} {\sum }_{q = 0}^{M - 1} {Z}_{2} ( p , {w}_{q} ) {W}_{M}^{q ( n - pR )} \\ for q = 0 , … , M - 1\end{matrix} \qquad ( 18 )$$

wherein hₛ(n) are the balancing coefficients in the interior of the synthesis window.

The reference signal e taken at the level of the loudspeaker is subjected, like the microphone signals, to a short-term Fourier transfer in 1208 after being balanced by 1206. The representation of e in the frequency domain, as obtained at the output of 1208, is described by the preceding notations:

$$\begin{matrix}E ( p , {w}_{q} ) = {\sum }_{n = 0}^{M - 1} {h}_{a} ( - n ) e ( pR + n ) {W}_{M}^{- qn} \\ pour q = 0 , … , M - 1 & ( 19 ) \\ Y ( p , {w}_{q} ) = {\sum }_{i = 1}^{N} {a}_{i} ( {w}_{q} ) {X}_{i} ( p , {w}_{q} ) & ( 20 )\end{matrix}$$

Filtering of this signal by the postfilter depends on the state of the binary signal K(p). If K(p)=1, that is, when the useful signal is present, the output signal is expressed in a frequency representation:

Z₂(p,w_{q})=Y(p,w_{q})W(p,w_{q})G(p) (21)

In the opposite case, K(p)=0, that is, when the useful signal is absent, the output signal is expressed as follows:

Z₂(p,w_{q})=Y(p,w_{q})Wₑ²(p,w_{q})G_{SA}(w_{q})G(p) (22)

wherein G_{SA}(ω_{q}) is the inverse of the frequency response of the coupling between the loudspeaker and the acoustic antenna. In fact, for certain applications, the sound intake system and the loudspeaker are situated at fixed sites. The coupling between the two transducers is then obtained by a previous measure. Thus, the gain G_{SA}(ω_{q}) constitutes a fixed compensation filter which suppresses a part of the disturbance.

The estimate of the transfer functions of the postfilters Wₑ(p,ω_{q}) and Wₛ(p,ω_{q}) respectively is carried out by the estimation modules 1251 and 1241. If these estimates are implemented by (1) and (12), the following is obtained:

$$\begin{matrix}{W}_{e} ( p , {w}_{q} ) = \frac{{\hat{Φ}}_{ee}^{LT} ( p , {w}_{q} )}{{\hat{Φ}}_{ee}^{CT} ( p , {w}_{q} )} & ( 23 ) \\ {W}_{e} ( p , {w}_{p} ) = \frac{{\sum }_{i - 1}^{N} {\vert {b}_{i} ( {w}_{p} ) \vert}^{2} γ ( {\sum }_{i = 1}^{N - 1} {\sum }_{j = i + 1}^{N} {\hat{Φ}}_{{v}_{i} {v}_{j}} ( p , {w}_{q} ) )}{γ ( {\sum }_{i - 1}^{N - 1} {\sum }_{j = i + 1}^{N} {b}_{i} ( {w}_{p} ) {b}_{j}^{*} ( {w}_{p} ) ) {\sum }_{i = 1}^{N} {\hat{Φ}}_{{v}_{i} {v}_{j}} ( p , {w}_{q} )} & ( 24 )\end{matrix}$$

The thus-obtained values of Wₑ(p,ω_{q}) are always positive and set between 1 and a predetermined value typically lower than 1 and which corresponds to the maximum attenuation of the interfering signal.

W(p,ω_{q}) is calculated as a product (in 1225) of Wₑ(p,ω_{q}) and Wₛ(p,ω_{q}). To limit the effect of estimation errors and to avoid undesirable amplifications, in practice, W(p,ω_{q}) is reduced in the manner pertaining to the interval [−1;1].

To estimate \hat{Φ}ₑₑ^{CT}(t,f) in (23), the recursive equation (2) is used, that is:

\hat{Φ}ₑₑ^{CT}(p,w_{q})=α\hat{Φ}ₑₑ^{CT}(p−1,w_{q})+(1−α)E(p,w_{q})E*(p,w_{q}) (25)

wherein α is a short-term time constant.

As indicated in (3) and (4), a long-term α₁ or short term α₂ time constant, according to which \hat{Φ}ₑₑ^{LT}(t,f) is lower or higher than \hat{Φ}ₑₑ^{CT}(t,f), is used to estimate \hat{Φ}ₑₑ^{LT}(t,f):

Si \hat{Φ}ₑₑ^{CT}>\hat{Φ}ₑₑ^{Lt} then \hat{Φ}ₑₑ^{LT}(p,w_{q})=α₁\hat{Φ}ₑₑ^{LT}(p−1,w_{q})+(1−α₁)E(p,w_{q})E*(p,w_{q}) (26)

Si \hat{Φ}ₑₑ^{CT}≦\hat{Φ}ₑₑ^{Lt} then \hat{Φ}ₑₑ^{LT}(p,w_{q})=α₂\hat{Φ}ₑₑ^{LT}(p−1,w_{q})+(1−α₂)E(p,w_{q})E*(p,w_{q}) (27)

It should be noted that α₁ is much closer to 1 than α₂. Concretely, it is advantageous to chose α₁=0.9999 and α₂=0.9 for the suggested implementation.

In the present example, the detection of the useful signal is implemented from a statistical analysis of frequency values of the filter W(p,ω_{q}) alone. The functional diagram of the statistical analysis module 1261 is illustrated in FIG. 13.

In 1321, a group of frequencies F_{ocp}^{W} fixed by the user is extracted from W(p,ωq). Typically, a frequency band is selected where the signal to be detected is well represented in order to have optimum detection and avoid a costly calculation over the entire band. For the speech signal, F_{ocp}^{W}=[1 kHZ; 3kHz]) is typically used. In 1322, the components at the frequencies of F_{ocp}^{W} are limited by means of a predetermined threshold SOC^{W}. Among all of the frequencies F_{ocp}^{W} thus retained in W(p,F_{ocp}^{W}), the frequency rates τ_{ocp}^{W} are determined for which W(p,ω_{q}) exceeds a threshold SOC^{W}, such as:

$${τ}_{ocp}^{W} ( p ) = \frac{ size of pectrum \\ in {F}_{ocp}^{W} such as ( p , {F}_{ocp}^{W} ) > {SOC}^{W}}{size of s pectrum of {F}_{ocp}^{W}} \qquad ( 28 )$$

The occupation rate τ_{ocp}^{W} is then compared with the occupation threshold STOC^{W} in the comparator 1324. The comparator derives a binary indicator p_a^{w}(p) for the presence of the useful signal which here is no other than the global indicator P_A(p), since here only the transfer function W(p,ω_{q}) is used for detecting the useful signal. To sum up:

P_{—}A(p)=1 si τ_{ocp}^{W}(p)>STOC^{w} (29)

P_{—}A(p)=0 si τ_{ocp}^{W}(p)≦STOC^{w} (30)

The diagram of the gain smoothing filter 762 is illustrated in FIG. 14. As illustrated above, the function of this filter is to continuously cause the gain G(p) to decrease toward a predetermined value Sₘᵢₙ during the transistion from state P (P_ A(p)=1) to state A (P_A(p)=0), and continuously cause G(P) to increase toward a predetermined value Sₘₐₓ (here fixed to 1 for ensuring the transparency of the gain in the presence of the useful signal) during the transition in the inverse direction.

In this example, the gain smoothing filter is numerical. The gain G(p) is smoothed by a recursive filter conditioned by the state of P_A(p):

G(p)=β_{P}G(p−1)+(1−β_{P})Sₘₐₓ if P_{—}A(p)=1 (31)

G(p)=β_{A}G(p−1)+(1−β_{A})Sₘᵢₙ if P_{—}A(p)=0 (32)

The quantities β_{P} and β_{A} are time constants which respectively fix the rates the rise and fall times of G(p). More precisely, the predetermined gains Sₘᵢₙ and Sₘₐₓ are switched by the binary indicator P_A(p) to the common output of the switch 1410. This output is connected on one side to the input of the recursive filter 1420 having the time constant β_{A} and to the input of the recursive filter 1430 having time constant β_{P}. The outputs of the two filters are switched by the switch 1440, as commanded by the binary indicator P_A(p).

Coming back to FIG. 12, the switching of the antenna output is ensured by the switch 1230, as commanded by the signal K(p). Such switching permits the application of the signal of the antenna output Y(p,ω_{q}) either to the postfilter 1240 or to the postfilter 1245. The switching signal K(p) is obtained by comparing the smoothed gain G(p) with a predetermined threshold ST, such as

K(p)=1 if G(p)>ST (33)

K(p)=0 if G(p)≦ST (34)

Although, for reasons of a clear representation, the invention has essentially been described in the form of functional modules, each carrying out a function, a person skilled in the art understands that in practice these modules could be implemented by means of a single processor carrying out these different functions or by means of a plurality of processors, whether specialized or not, carrying out one or several of the above-mentioned functions.

In addition, it should be stressed that the invention is not limited to acoustic echo elimination in a multi-pickup sound intake system, but generally applies to any multi-pickup reception system using as a reference of one or more interference signals.

1. Interference reduction method for a reception system using a multi-pickup antenna and at least one path generator supplying an antenna signal from signals received by the different pickups of the above-mentioned antenna, characterized in that the transfer function of a first filter, called a first postfilter, is estimated from a reference signal making it possible to regenerate the above-mentioned interference, and the above-mentioned antenna signal is filtered by the above-mentioned first postfilter.

2. Interference reduction method according to claim 1, characterized in that the above-mentioned transfer function is obtained from a short-term estimate and a long-term estimate of the spectral density of the above-mentioned reference signal.

3. Interference reduction method according to claim 2, characterized in that the above-mentioned transfer function is obtained from a ratio of the long-term estimate and the short-term estimate of the above-mentioned spectral density.

4. Interference reduction method according to claim 2 or 3, characterized in that the short-term estimate and the long-term estimate of the spectral density are obtained by a low-pass filtration of a spectrum of the reference signal.

5. Interference reduction method according to claim 4, characterized in that the short-term estimate \hat{Φ}ₑₑ^{CT}(t,f) of the spectral density is obtained by a recursive filtering of the type
\hat{Φ}ₑₑ^{CT}(t,f)=α\hat{Φ}ₑₑ^{CT}(t−δt,f)+1−α)E(t,f)E*(t,f)
wherein E(t,f) is a spectral component of the reference signal at the frequency f and at the point in time t, a is a coefficient between 0 and 1, δt is the delay in the loop of the recursive filtration and .* indicates the conjugation operation.

6. Interference reduction method according to claim 5, characterized in that the long-term estimate \hat{Φ}ₑₑ^{LT}(t,f) of the spectral density is obtained by a recursive filtering of the following type
\hat{Φ}ₑₑ^{LF}(t,f)=α₁\hat{Φ}ₑₑ^{LT}(t−δt,f)+(1−α₁)E(t,f)E*(t,f) if \hat{Φ}ₑₑ^{LT}(t,f)<\hat{Φ}ₑₑ^{CT}(t,f)
and
\hat{Φ}ₑₑ^{LT}(t,f)=α₂\hat{Φ}ₑₑ^{LT}(t−δt,f)+(1−α₂)E(t,f)E*(t,f) if \hat{Φ}ₑₑ^{LT}(t,f)≧\hat{Φ}ₑₑ^{CT}(t,f)
wherein α₁ and α₂ are coefficients, such as 0<α₂<α₁<1.

7. Interference reduction method according to one of the preceding claims, the signals received by the different pickups being filtered by at least one set of the path filters before being added up for supplying the above-mentioned antenna signal, characterized in that the transfer function of a second filter, called second postfilter, is estimated from the above-mentioned received signals, before or after the filtration by the above-mentioned path filters, and in that the antenna signal is filtered by the above-mentioned second postfilter.

8. Interference reduction method according to claim 7, characterized in that the transfer function of the above-mentioned second postfilter is estimated from a mean of the spectral densities of the power and from a mean of the interspectral densities of the power of the above-mentioned received signals, after the filtration by the above-mentioned path filters.

9. Interference reduction method according to claim 8, characterized in that the transfer function Wₛ(t,f) of the above-mentioned second postfilter is estimated by
$${\hat{W}}_{s} ( t , f ) = \frac{{\sum }_{i - 1}^{N} {\vert {b}_{i} ( f ) \vert}^{2} γ ( {\sum }_{i = 1}^{N - 1} {\sum }_{j = i + 1}^{N} {\hat{Φ}}_{{v}_{i} {v}_{j}} ) ( t , f )}{γ ( {\sum }_{i - 1}^{N - 1} {\sum }_{j = i + 1}^{N} {b}_{i} ( f ) {b}_{j}^{*} ( f ) ) {\sum }_{j = i + 1}^{N} {\hat{Φ}}_{{v}_{i} {v}_{i}} ( t , f )}$$
wherein \hat{Φ}ᵥ_{ᵢ}ᵥ_{ᵢ}(t,f) and \hat{Φ}ᵥ_{ᵢ}ᵥ_{ⱼ}(t,f) respectively are estimates of the spectral densities and the interspectral densities of the power of the received signals after the path filtration, bᵢ(f) are the transfer functions of the different path filters relieved of the rephasing terms, N is the number of pickups of the antenna and γ(.) indicates the real value or the module.

10. Interference reduction method according to one of claims 1 to 6, the signals received by the different pickups being filtered by at least one set of the path filters before being added-up for supplying the above-mentioned antenna signal, characterized in that the transfer function of a second filter, the above-mentioned second postfilter, is estimated from the above-mentioned signals received after the filtration by the above-mentioned path filters, as well as from the antenna signal, and the antenna signal is filtered by the above-mentioned second postfilter.

11. Interference reduction method according to claim 10, characterized in that the transfer function of the above-mentioned second postfilter is estimated from a mean of interspectral densities of the power of the above-mentioned received signals, after the filtration by the above-mentioned path filters, and from an estimation of the spectral density of the antenna signal.

12. Interference reduction method according to claim 11, characterized in that the transfer function Wₛ(t,f) of the above-mentioned second postfilter is estimated by
$${\hat{W}}_{s} ( t , f ) = \frac{\frac{2}{{N ( N - 1 )}^{γ}} ( {\sum }_{i = 1}^{N - 1} {\sum }_{j = i + 1}^{N} {\hat{Φ}}_{{v}_{i} {v}_{j}} ) ( t , f )}{ {\hat{Φ}}_{yy} ( t , f )}$$
wherein \hat{Φ}ᵥ_{ᵢ}ᵥ_{ⱼ}(t,f) and \hat{Φ}_{yy}(t,f) respectively are the spectral and interspectral densities of the power of the received signals after the path filtration, bᵢ(f) are the transfer functions of the different path filters relieved of the rephasing terms, N is the number of pickups of the antenna and γ(.) indicates the real value or the module.

13. Interference reduction method according to one of claims 7 to 12, characterized in that the filtration of the antenna signal by the first postfilter and that of the second postfilter are applied in a combined manner, while filtering the antenna signal by means of a postfilter, the above-mentioned first combined postfilter having a combination of the transfer functions of the above-mentioned first and second postfilters as the transfer function.

14. Interference reduction method according to claim 13, characterized in that a statistical analysis is carried out of the spectral components of the transfer function of the second postfilter and/or of the transfer function of the first combined postfilter, and an indication of the presence or absence of a useful signal is deduced therefrom.

15. Interference reduction method according to claim 14, characterized in that the statistical analysis is also carried out with respect to the spectral components of the transfer function of the first postfilter.

16. Interference reduction method according to claim 14 or 15, characterized in that the above-mentioned statistical analysis uses a spectral occupation rate criterion and/or a variance criterion of the above-mentioned spectral components.

17. Interference reduction method according to one of claims 14 to 16, characterized in that a switching signal is generated from the above-mentioned indication of the presence or absence of the useful signal, and the antenna signal is filtered by means of the first combined postfilter when the switching signal is in a first state, and it is filtered by means of a second combined postfilter when the switching signal is in a second state, the transfer function of the second combined postfilter being a combination of the transfer function of the first postfilter and of a predetermined attenuation.

18. Interference reduction method according to one of claims 7 to 12, the received signals are filtered by a plurality of path filter sets for forming a plurality of path signals,
characterized in that a statistical analysis is carried out of the spectral components of the transfer functions of the second postfilters associated with different path filter sets, and in that the path offering the highest probability of the presence of a useful signal is deduced therefrom.

19. Interference reduction method according to claim 18, characterized in that the statistical analysis is also carried with respect to spectral components of the transfer function of the first postfilter.

20. Interference reduction method according to claim 18 or 19, characterized in that the above-mentioned statistical analysis uses a spectral occupation rate criterion and/or a variance criterion of the above-mentioned spectral components.

21. Interference reduction method according to one of claims 18 to 20, characterized in that the antenna signal is obtained from path signals relative to the path offering the highest probability of the presence of the useful signal.

22. Reception system comprising a multi-pickup antenna, at least one path generator and interference reduction devices, characterized in that the above-mentioned interference reduction devices comprise a filter in the output of the path generator, the above-mentioned first postfilter, and devices for estimating from a reference signal permitting the generating of the above-mentioned interference the transfer function of the above-mentioned postfilter.

23. Reception system comprising a multi-pickup antenna, at least one path generator and devices for the interference reduction, characterized in that the above-mentioned interference reduction devices are adapted to implement the interference reduction method according to one of claims 1 to 21.
